(19) United States
(12) Patent Application Publication
(10) Pub. No.: US 2019/0204186 A1
(43) Pub. Date: Jul. 4, 2019

(54) RUNNING DRUM ARRANGEMENT FOR A TIRE TESTING STAND AND TIRE TESTING STAND WITH THE RUNNING DRUM ARRANGEMENT

(71) Applicant: ZF Friedrichshafen AG, Friedrichshafen (DE)

(72) Inventor: Jens EISENBEISS, Fuerstenzell (DE)

(21) Appl. No.: 16/311,854

(22) PCT Filed: May 22, 2017
(86) PCT No.: PCT/EP2017/062205

§ 371 Date: Dec. 20, 2018

(30) Foreign Application Priority Data
Jun. 22, 2016 (DE) 10 2016 211 203.1

(51) Int. Cl. G01M 17/02

(52) U.S. Cl. CPC G01M 17/022

(57) ABSTRACT

A running drum arrangement for a tire testing stand having a running drum. The running drum defines an axis of rotation. The running drum has at least one fastener mount and the fastener mount defines a main axis. At least one impact strip is arranged on a radial outer side of the running drum with respect to the axis of rotation. At least one fastener fastens the impact strip to the running drum and the fastener is received in the fastener mount. The running drum arrangement has at least one molded piece. The molded piece is arranged between the running drum and the impact strip. The molded piece forms a form fit, with the running drum and with the impact strip, in a circumferential direction with respect to the axis of rotation.

This application is a National Stage completion of PCT/EP2017/062205 filed May 22, 2017, which claims priority from German patent application serial no. 10 2016 211 203.1 filed Jun. 22, 2016.

### FIELD OF THE INVENTION

The invention relates to a running drum arrangement for a tire testing stand and to a tire testing stand having the running drum arrangement.

### BACKGROUND OF THE INVENTION

For fastening impact strips on running rollers of tire testing stands, the impact strips are mounted on the running rollers by simple screw connections. In this case the loads occurring in the circumferential direction must be transferred from the impact strip to the drum by friction. There, the fastening screws are subjected to considerable bending stress. Therefore, only relatively small loads are permissible in the circumferential direction for this fastening concept. The embodiment of the impact strip fastening therefore limits the permissible tire contact force, shape and height of the impact strip, roll-over speed and cross-sectional shape of the tire.

DE 580 895 C discloses a support rail having a pressure plate for bump bars of threshing machine drums, the bump bars of which are equipped with a base having a trapezoidal cross section. IN this case, the bump bar is connected in a form-fitting manner by two elements connected to the threshing machine drum by screw connections, a support rail and a pressure plate, independently of the bump bar. No further fasteners for fastening the bump bar to the threshing machine drum are provided.

Document DE 299 23 728 U1, which probably constitutes the closest prior art, describes a running drum for a vehicle testing stand or drum test machine, wherein a segment of the running surface can be removed and an obstruction having a negative radial elevation can be inserted. A faced support plate, onto which different obstructions and the removable original running surface piece can be screwed, is welded into the outer cylinder surface of the running drum. Because its mounting times during testing operation are the shortest, the screwed-on impact strip has become established as the simplest solution for the individual obstructions.

### SUMMARY OF THE INVENTION

The invention addresses the problem of proposing a running drum arrangement for a tire testing stand that permits greater stressing of the impact strips.

This problem is solved by a running drum arrangement for a tire testing stand having the features of the independent claims and by a tire testing stand having the running drum arrangement having the features of the independent claims. Preferred or advantageous embodiments of the invention will be apparent from the subordinate claims, the following description and/or the appended figures.

According to the invention, a running drum arrangement for a tire testing stand is proposed. In particular, the running drum arrangement has the function of simulating an impact strip test for a vehicle tire, preferably at different speeds. In particular, the vehicle tire is a car tire or a motorcycle tire or a truck tire.

The running drum arrangement has a running drum. In particular, the running drum has the function of simulating a road surface. In particular, a test load is applied to the vehicle tire so that, for example, a tire contact force is simulated. The running drum is preferably cylinder shaped, wherein the outer cylinder surface forms a running surface. In particular, the running drum and the vehicle tire are moveable relative to each other so that preferably the vehicle tire, in particular the circumferential surface of the vehicle tire, remains in contact and/or can be brought into contact with the running drum, in particular with the running surface. In particular, the running drum has a road surface or steel surface. The running drum is preferably driven by a drive device.

The running drum defines an axis of rotation. In particular, the running drum is mounted coaxially to the axis of rotation. The running drum is preferably connected to the drive device by a transmission.

The running drum has at least one fastener mount for mounting a fastener. In particular, the fastener mount is configured as a drilled hole or penetration, etc. The fastener mount preferably extends radially from the running surface of the running drum toward the axis of rotation. The fastener mount preferably has a female thread, preferably a metric thread. In particular, the running drum has a plurality of fastener mounts. In particular, the fastener mounts are evenly spaced apart from one another in a circumferential direction and/or in an axial direction with respect to the axis of rotation. The fastener mount defines a main axis. In particular, the main axis is an axis of symmetry or a centerline or center axis. In particular, the main axis extends in a radial direction with respect to the axis of rotation.

The running drum assembly has at least one impact strip. In particular, the impact strip is a metal bar or a plastic bar or a composite material bar. The impact strip preferably has a rectangular or an acute-angled or a square or a round profile. In particular, the impact strip has a height greater than 5 mm, preferably greater than 20 mm, specifically greater than 80 mm. Alternatively, or optionally in addition, the impact strip has a height less than 100 mm, preferably less than 60, specifically less than 10 mm.

The impact strip is arranged on a radial outer side of the running drum with respect to the axis of rotation. In particular, the impact strip is arranged on the running surface of the running drum. In particular, the running drum arrangement has more than two, specifically more than four impact strips. Preferably, the impact strips are and/or can be evenly spaced apart from one another in a circumferential direction.

The running drum arrangement has at least one fastener for fastening the impact strip on the running drum. In particular, the fastener has the function of holding the impact strip in place on the radial outer side of the running drum such that the impact strip is preferably secured against coming off. In particular, the impact strip is connected, completely or in part, to the running drum in a force-fitting and/or form-fitting and/or friction-fitting manner. In particular, the fastener is configured as a screw element and/or as a tightening element and/or as a clamping element. The fastener is received in the fastener mount. In particular, the fastener is screwed and/or tightened and/or pushed and/or clamped in the fastener mount.

In particular, the fastener or screw element is a hex head screw or a flat-head screw or a countersunk screw; however, particular preference is given to the fastener being a socket cap screw. In particular, the fastener has a male thread, preferably a metric thread. In particular, the fastener can be engaged with the female thread of the fastener mount.

In the context of the invention, it is proposed that the running drum arrangement has at least one molded piece. In particular, the molded piece has the function of reducing a load acting on the fastener. In particular, the molded piece has a round or square or rectangular or oval shape when viewed from above. In particular, the molded piece is made of plastic or metal, preferably of a metal alloy or of a composite material. In particular, the molded piece is formed separately from the fastener.

The molded piece is preferably arranged between the running drum and the impact strip. In particular, the molded piece is arranged coaxially and/or concentrically to the main axis. Preferably, the molded piece is and/or can be inserted in the fastener mount. In particular, the molded piece has a molded piece hole. The molded piece hole is preferably configured for mounting and/or guiding the fastener.

The molded piece interlocks with the running drum and with the impact strip in a circumferential direction with respect to the axis of rotation. During mounting of the impact strip, in particular in a first mounting step, the molded piece is inserted on the running drum, preferably into the fastener mount. Depending on the length of the running drum and/or the length of the impact strip, additional molded pieces are preferably inserted in additional fastener mounts.

In a second mounting step, in particular the impact strip is positioned on the molded piece such that the molded piece preferably interlocks with the impact strip and with the running drum in a circumferential direction with respect to the axis of rotation and/or in a radial direction with respect to the main axis.

In a third mounting step, in particular the fastener is introduced into the fastener mount such that the impact strip and the molded piece are then preferably locked to the running drum radially toward the axis of rotation by means of the fastener.

In particular, the impact strip has at least one fastener guidance hole for guiding the fastener. In particular, the fastener guidance hole is a drilled hole or a penetration. Preferably, the fastener guidance hole is and/or can be arranged coaxially to the main axis. In particular, the fastener is and/or can be inserted axially along the main axis, through the fastener guidance hole, the molded piece hole and into the fastener mount. The fastener guidance hole is preferably configured as a countersunk drilled hole such that in particular the screw element, preferably a screw element head, can be countersunk in the impact strip. In particular, the countersunk drilled hole has a conical or cylindrical countersink.

The advantage of the invention lies particularly in the fact that the molded piece, by virtue of the form fit with the impact strip and with the running drum, absorbs a load or at least a partial load in a circumferential direction and can thus significantly reduce a bending stress on the fastener. Greater loads are thus also possible in the impact strip test. Furthermore, the impact strip does not have any other notches, especially not at the heavily stressed screw connection points. Comparatively very high loads can thus be absorbed in the circumferential direction. Another advantage lies in the economical production of the impact strips, in particular because little machining effort is required. Particularly advantageous is the fact that only one set of molded pieces has to be produced for each impact strip width, wherein then not only impact strips of varying height but also impact strips at any angle can be fastened to the drum. Even if two or more molded pieces are used per impact strip, an oblique fastening and mounting at an angle other than 0 is still possible without any problem.

In a preferred design of the invention, the molded piece forms a first form fit coupling with the impact strip and a second form fit coupling with the running drum. In particular, the first and/or the second form fit coupling is a form fit in the circumferential direction and/or in the radial direction with respect to the axis of rotation. Alternatively, or optionally in addition, the first and/or the second form fit coupling is a form fit in the radial and/or axial direction with respect to the main axis.

The first form fit coupling receives a load, which preferably acts on the impact strip during a test process, in a circumferential direction and transmits the load to the running drum via the second form fit coupling. In particular, the load is a force acting in a circumferential direction, preferably a tangential force, which acts on the impact strip.

In another preferred design of the invention, the molded piece has a first and a second installation section. In particular, the two installation sections have the function of holding the impact strip in place. In particular, the molded piece has a groove, wherein the groove preferably serves as a guide for the impact strip. In particular, the first and second installation sections are formed by the groove. In particular, the two installation sections are configured as webs or sides. The two installation sections preferably run parallel to each other.

In particular, the two installation sections extend toward the impact strip in an axial direction with respect to the main axis, preferably radially away from the axis of rotation. In particular, the two installation sections have a height of at least 1 mm, preferably greater than 5 mm, specifically greater than 10 mm. Alternatively, or optionally in addition, in particular the two installation sections have a height of less than 20 mm, preferably less than 8 mm, specifically less than 3 mm.

The two installation sections encompass the impact strip on both sides and form the first form fit coupling in the radial direction with respect to the main axis. In particular, the two installation sections encompass engage around the impact strip, holding it such that a force acting on the impact strip, (e.g., the tangential force) is preferably transferred to at least one of the two installation sections. In particular, the two installation sections encompass the impact strip in such a way that in the case of a missing fastener, the impact strip is only displaceable within the groove and/or forcibly guided in the groove. In particular, the two side faces run parallel to each other and preferably define a width of the impact strip.

In a preferred implementation, the first installation section abuts a first side face of the impact strip in a form-fitting manner and/or the second installation section abuts a second side face of the impact strip in a form-fitting manner. In particular, the two installation sections are spaced at a distance from each other in such a way that the distance corresponds to the width of the impact strip. The impact strip is preferably arranged free of play, specifically in a form-fitting and/or in a friction-fitting and/or in a force-fitting manner, or with slight play between the two installation sections. In particular, the play is less than 2 mm, preferably less than 0.5 mm, specifically less than 0.1 mm. In particular, the impact strip has a width greater than 10 mm, preferably greater than 30 mm, specifically greater than 100 mm. Alternatively, or optionally in addition, in particular the impact strip has a width of less than 200 mm, preferably less than 50 mm, specifically less than 15 mm.

The fastener mount preferably has an abutment section. In particular, the fastener mount has an abutment section for mounting the molded piece and an abutment section for mounting the fastener. In particular, the abutment section is prism-shaped or cuboid-shaped or cylindrical. In particular, the abutment section forms a contour partner to the contact section. The abutment section preferably has a larger diameter than does the mounting section. However, particular preference is given to the fastener mount being configured as an additional countersunk drilled hole. The additional countersunk drilled hole preferably has a cylindrical countersink, wherein particular preference is given to the cylindrical countersink forming the abutment section.

The molded piece has a contact section. In particular, the contact section has the function of centering the molded piece in a radial and/or axial direction with respect to the main axis and preferably of transmitting the load to the abutment section or to the running drum. In particular, the contact section is cylindrical or cube-shaped or cuboid-shaped or prism-shaped.

The contact section has a first and a second contact area. In particular, an outer surface of the contact section forms the first contact area. In particular, a base surface of the contact section forms the second contact area. However, particular preference is given to an outer cylinder surface forming the first contact area and a base cylinder surface forming the second contact area. In particular, the contact section extends coaxially to the main axis and/or radially toward the axis of rotation R. Particular preference is given to the contact section being configured as a hollow cylinder.

The molded piece forms, with the abutment section, the second form fit coupling in a radial and/or axial direction relative to the main axis. In particular, the abutment section has a first and a second abutment subsection. In particular, the first abutment subsection is an inner surface of the abutment section and the second abutment subsection is a base surface of the abutment section. However, particular preference is given to the first abutment subsection being an inner cylinder surface of the abutment section or of the cylindrical countersink. The second abutment subsection is preferably a planar base surface of the abutment section or of the cylindrical countersink.

In particular, the first contact area forms, in conjunction with the first abutment subsection, the second form fit coupling in a radial direction with respect to the main axis. Alternatively, or optionally in addition, the second contact forms, in conjunction with the second abutment subsection, the second form fit coupling in a radial direction with respect to the main axis. In particular, the first and/or the second contact area can be and/or are pushed completely and/or partially axially along the main axis toward the axis of rotation into the fastener mount, preferably into the abutment section.

The first and/or the second contact areas are arranged in the abutment section preferably free of play, specifically in a form-fitting and/or friction-fitting and/or force-fitting manner. Alternatively, the first and/or the second contact areas are arranged in the abutment section with slight play. The play is in particular less than 2 mm, preferably less than 0.5 mm, specifically less than 0.1 mm.

In an engineering implementation, the molded piece has a bottom bearing section. In particular, the bottom bearing section extends in a radial direction with respect to the main axis. The bottom bearing section preferably forms a circular ring, particularly when viewed from below. In particular, a circular ring area of the circular ring forms the bottom bearing section. In particular, the contact section adjoins the inner circle of the circular ring.

The bottom bearing section rests on the running surface and forms, in conjunction with the running drum, preferably in conjunction with the running surface, a form fit in a radial direction with respect to the axis of rotation. In particular, the bottom bearing section rests entirely or in part on the radial outer side of the running drum and radially forms a form fit toward the axis of rotation. Alternatively, the bottom bearing section is spaced at a distance from the running drum, wherein in particular the molded piece forms, in conjunction with the second contact area, the form fit in a radial direction with respect to the axis of rotation.

In another engineering constructive implementation, the molded piece has a top bearing section. In particular, the top bearing section extends in a radial direction with respect to the main axis. In particular, the two installation sections adjoin the top bearing section in an opposing direction to the contact section. In particular, the two installation sections are arranged at right angles to the top bearing section.

The top bearing section rests on a bottom of the impact strip and forms a form fit in a radial direction with respect to the axis of rotation in conjunction with the impact strip. In particular, the impact strip in a mounted state rests on the top bearing section, wherein the fastener preferably tightens the impact strip and the molded piece.

In a preferred further development, the impact strip has a recess on the bottom. In particular, the recess has the function of mounting the molded piece such that the bottom of the impact strip preferably rests entirely on the running drum and/or on the molded piece. In particular, the recess has the advantage of avoiding over determination. The impact strip preferably rests on either the molded piece or particularly preferably on the running drum.

The recess extends, in sections, in the area of the molded piece in the longitudinal extension and/or in the transverse extension of the impact strip. In particular, the recess is created by means of a separation process and/or a shaping process and/or a primary shaping process. In particular, the recess is a groove or a drilled hole or a notch. In particular, the recess extends on the bottom of the impact strip, over the entire width. In particular, the recess is delimited in the longitudinal extension of the impact strip, wherein the recess preferably corresponds to at least the outer diameter of the molded piece.

In an alternative or optional additional design, the impact strip has a hollow at the bottom. In particular, the hollow has the function of forming another form fit coupling in a circumferential direction and/or in an axial direction with respect to the axis of rotation.

The hollow extends, entirely or in part, in the longitudinal extension and/or in the transverse extension of the impact strip. In particular, the hollow is created by means of the separation process and/or the shaping process and/or the primary shaping process. In particular, the hollow is configured as a groove or as a drilled hole or as a depression. In particular, the hollow preferably runs along the entire length on the bottom of the impact strip. Alternatively, the hollow only runs along the bottom of the impact strip in the area of the molded piece in the longitudinal direction.

The hollow forms a first and a second web section, wherein the web sections encompass the molded piece on both sides. In particular, the web sections run parallel to each other. The web sections are preferably spaced at a distance from each other in the longitudinal extension and/or in the transverse extension in such a way that the molded piece is and/or can be arranged between the two web sections free of play, preferably in a form-fitting and/or force-fitting and/or friction-fitting manner.

Alternatively, or optionally in addition, the two web sections run across the width of the impact strip on the bottom so that the molded piece interlocks with the impact strip in an axial direction with respect to the axis of rotation. Alternatively, or optionally in addition, the molded piece also has the two installation sections such that the molded piece forms a form fit, particularly in a radial direction with respect to the main axis, and preferably attaches the impact strip in its entirety.

In a preferred implementation, the impact strip can be fastened on the running drum parallel to or skewed with respect to the axis of rotation. In particular, the impact strip has a plurality of fastener guidance holes. In particular, a molded piece is allocated to at least one, preferably to each fastener guidance hole. In particular, the impact strip has at least two, preferably at least four, specifically more than six fastener guidance holes, wherein in particular a molded piece is allocated to each fastener guidance hole. In particular, the molded pieces are rotatable in the fastener mount such that the molded pieces, depending on the arrangement of the impact strip on the running drum, can be aligned.

In a first mounting position, the impact strip is arranged parallel to the axis of rotation. In particular, in the first mounting position the impact strip defines an installation axis, wherein the installation axis preferably runs parallel to the axis of rotation. In particular, the impact strip can be arranged in other mounting positions, wherein the impact strip in the other mounting positions is and/or can be twisted and/or offset with respect to the installation axis. In the other mounting positions, the impact strip preferably forms an angle with the installation axis. In particular, said angle is greater than 10°, preferably greater than 25°, specifically greater than 65°. Alternatively, or optionally in addition, the angle is in particular less than 75°, preferably less than 50°, specifically less than 20°.

In a preferred further development, an elastomer layer is arranged between the impact strip and the running drum, over the entire area or in part. In particular, the elastomer layer has the function of compensating tolerances and/or of preventing damage to the running drum. In particular, the elastomer layer is and/or can be arranged on the bottom of the impact strip. In particular, the elastomer layer is arranged over the entire bottom of the impact strip.

Alternatively, the elastomer layer is arranged, particularly in sections, between at least two molded pieces spaced at a distance from each other. In particular, the elastomer layer extends over more than 10%, preferably more than 40%, specifically more than 70% of the bottom of the impact strip. Alternatively, or optionally in addition, in particular the elastomer layer extends over less than 90%, preferably less than 60%, specifically less than 30% of the bottom of the impact strip.

In particular, the elastomer layer is arranged and/or can be arranged in a self-adhesive manner to the bottom of the impact strip and/or on the running drum, preferably on the radial outer side of the running drum. In particular, the elastomer layer is configured as a bar element, the bar element is for example a rubber bar, a foam bar, a sponge rubber bar, etc. In particular, the impact strip has at least one, preferably more than two, specifically more than six of such bar elements.

A tire testing stand having the running drum arrangement as described above or according to one of the preceding claims constitutes further subject matter of the invention.

### BRIEF DESCRIPTION OF THE DRAWINGS

Other features, advantages and effects of the invention will become apparent from the following description of preferred exemplary embodiments of the invention, wherein:

FIG. 1 shows a running drum assembly in a mounted position as an exemplary embodiment of the invention, in a three-dimensional view;

FIG. 2 shows a cross section along a main axis through a impact strip having a molded piece of the running drum arrangement;

FIG. 3a shows the molded piece of the running drum arrangement as an individual part, in a view from above;

FIG. 3b shows a front view of the molded piece of the running drum arrangement as an individual part;

FIG. 3c shows a perspective illustration viewed diagonally from behind of the molded piece of the running drum arrangement as an individual part;

FIG. 3d shows a perspective illustration viewed diagonally from in front of the molded piece of the running drum arrangement as an individual part;

FIG. 4 shows a partial three-dimensional view of the running drum arrangement with the impact strip;

FIG. 5 shows the running drum arrangement depicted in the same way as in FIG. 4, but having an alternative arrangement of the impact strip;

FIG. 6 shows the running drum arrangement with an elastomer layer, in an exploded partial view;

FIG. 7 shows a three-dimensional view of the impact strip as an individual part;

FIG. 8 shows the impact strip and the molded piece of the running drum arrangement depicted in the same way as in FIG. 2, but in an alternative engineering implementation;

FIG. 9 shows a longitudinal section along the main axis through the impact strip and the molded piece of the running drum arrangement.

Corresponding or identical parts are always identified by the same reference signs in the figures.

### DETAILED DESCRIPTION OF THE PREFERRED EMBODIMENTS

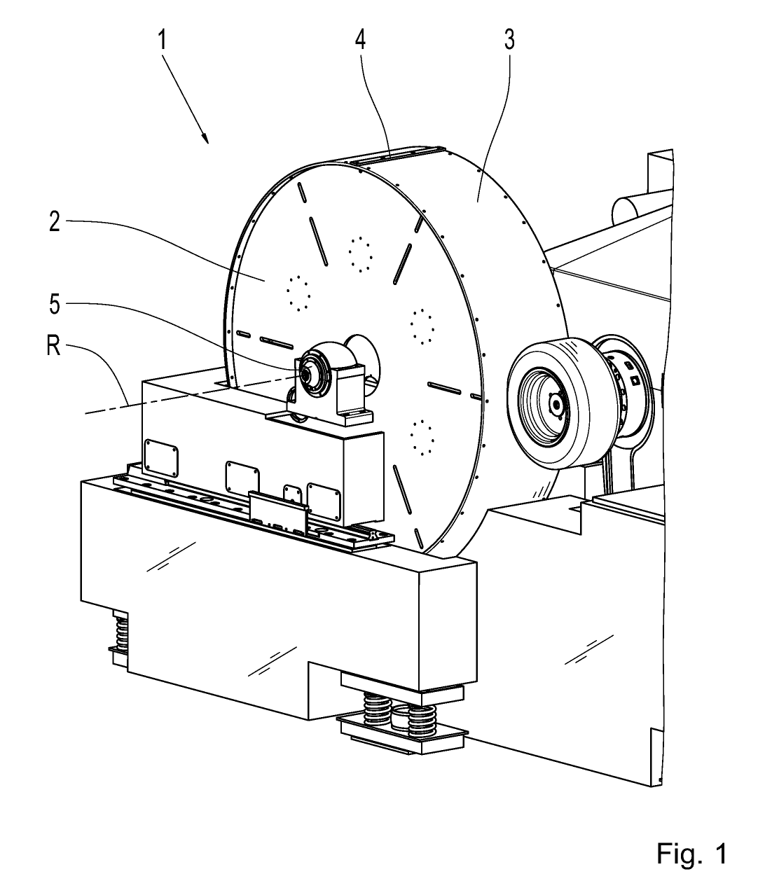

FIG. 1 shows a three-dimensional view of a running drum arrangement 1. For example, the running drum arrangement 1 is a component of a tire testing stand, e.g., a high-speed uniformity testing stand. The running drum arrangement 1 has a running drum 2. The running drum 2 has a cylindrical shape, wherein the outer cylinder surface forms a running surface 3. For example, a vehicle tire to be tested rolls on the running surface 3, wherein the vehicle tire is, for example, subjected to a test load such that a tire contact force is simulated.

For example, the running surface 3 has a road surface, corundum surface, metal surface, etc. The running drum 2 defines an axis of rotation R, wherein the running drum 2 is mounted in a running drum mount 5 such that it can rotate in a circumferential direction with respect to the axis of rotation R. For example, the running drum 2 is driven or set in rotation by a drive device.

The running surface 3 has at least one impact strip 4, which is illustrated schematically. For example, the impact strip 4 is a metal bar, a plastic bar, etc., wherein in the illustration shown, the impact strip 4 is fastened parallel to the axis of rotation R on the running surface 3, for example in a force-fitting and/or friction-fitting and/or form-fitting manner. For example, the running roller has additional impact strips, which are, e.g., evenly or unevenly spaced apart from one another in a circumferential direction with respect to the axis of rotation. The impact strip 4 has, e.g., the function of performing a impact strip test with a vehicle tire to be tested.

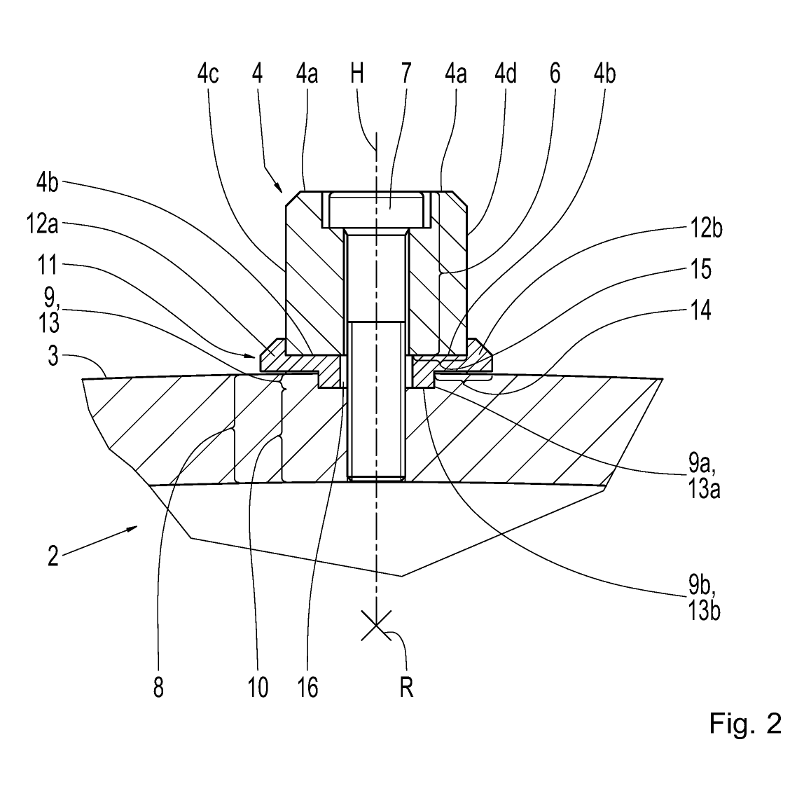

FIG. 2 shows the impact strip 4, a fastener 7, a molded piece 11, and the running surface 3 of the running drum 2 in a cross section along a main axis H. The impact strip 4 has a rectangular profile. The impact strip 4 can also have, for example, a triangular, square, round, etc. profile. The impact strip 4 has a impact strip top 4a and a impact strip bottom 4b as well as a first and a second impact strip side face 4c, 4d, wherein the four sides 4a-4d form the profile of the impact strip 4.

In the illustrated exemplary embodiment, the fastener 7 is configured as a cylinder-head screw. For example, the fastener 7 can be any kind of screw element, e.g., a countersunk screw, hex head screw, etc. or it can be also configured as, e.g., a quick-action clamping means. The impact strip 4 has at least one fastener guidance hole 6 for guiding the fastener 7. The fastener guidance hole 6 is a drilled hole, wherein the fastener 7 is guided through the fastener guidance hole 6 with slight play, e.g., at least 0.5 mm and/or at most 1 mm. The fastener guidance hole 6 has a cylindrical countersink in the area of the impact strip top 4a. The fastener 7 or the cylinder-head screw is arranged in the fastener guidance hole 6 in such a way that the fastener 7 is completely countersunk and the impact strip top 4a does not have any elevation.

The running surface 3 has at least one fastener mount 8 for mounting the fastener 7. The fastener mount 8 extends radially toward the axis of rotation R from the outer side of the running surface 3. The fastener mount 8 defines a main axis, e.g., based on the symmetry axis or based on the main axis, H. The main axis H intersects the axis of rotation R and is, for example, perpendicular to the axis of rotation R.

The fastener mount 8 has an abutment section 9 and a mounting section 10. The mounting section 10 is formed by a drilled hole and has a female thread such that the fastener 7 can be screwed into fastener mount 8 or into the mounting section 10. In the exemplary embodiment shown, the abutment section 9 is formed by a counterbore, in particular a cylindrical countersink. For example, the abutment section 9 can also be formed by a second drilled hole, in particular with a diameter larger than the diameter of the mounting section 10.

The abutment section 9 has a first and a second abutment subsection 9a, 9b. The first abutment subsection 9a is formed by the outer cylinder surface of the cylindrical countersink. The second abutment subsection 9b is formed by the planar base surface of the cylindrical countersink, wherein the second abutment subsection 9b forms a circular ring when viewed from above.

The molded piece 11 is arranged between the impact strip 4 and the running surface 3. The molded piece 11 has a first and a second installation section 12a, 12b for holding the impact strip 4 in place. The installation sections 12a, 12b form, in conjunction with the impact strip 4, a form fit in a radial direction with respect to the main axis H and/or in a circumferential direction with respect to the axis of rotation R. The first installation section 12a abuts the first impact strip side face 4c and the second installation section 12b abuts the second impact strip side face 4d such that the impact strip 4 is held in a form-fitting manner between the two installation sections 12a, 12b.

The molded piece 11 has a top and a bottom bearing section 14, 15. The two bearing sections 14, 15 extend in a radial direction with respect to the main axis H. The two installation sections 12a, 12b adjoin the top bearing section 15 parallel to the main axis H, wherein the two installation sections 12a, 12b extend toward the impact strip top 4a.

A contact section 13 adjoins the bottom bearing section 14 in an axial direction with respect to the main axis H. The contact section 13 has a first and a second contact area 13a, 13b. The first contact area 13a abuts the first abutment subsection 9a and forms, with the first abutment subsection 9a, a form fit in a radial direction with respect to the main axis H. The second contact area 13b abuts the second abutment subsection 9b and forms, with the second abutment subsection 9b, 9a form fit in an axial direction with respect to the main axis H.

The impact strip bottom 4b rests against the top bearing section 15 of the molded piece 11 so that a form fit is formed in an axial direction with respect to the main axis H and/or in a radial direction with respect to the axis of rotation R. In the illustration shown, the bottom bearing section 14 runs radially outwards with respect to the main axis H, with a slight play to the running surface 3. Alternatively, the bottom bearing section 14 rests entirely or in part on the running surface 3, wherein, for example, the second contact area 13b abuts the second abutment subsection 9b or is spaced apart from the second abutment subsection 9b.

The molded piece 11 has a molded piece hole 16. In a mounted state of the molded piece 11, for example, the fastener 7 passes through the molded piece 11 via the molded piece hole 16. The molded piece hole 16 is a drilled hole, wherein the drilled hole is drilled through the middle of the molded piece 11. The fastener guidance hole 6, the molded piece hole 16 and the fastener mount 8 are arranged coaxially to one another with respect to the main axis H. The fastener 7 is screwed and/or can be screwed axially along the main axis H into the fastener mount 8 such that the fastener 7 radially exerts a force on the impact strip 4 and the molded piece 11 toward the running surface 3.

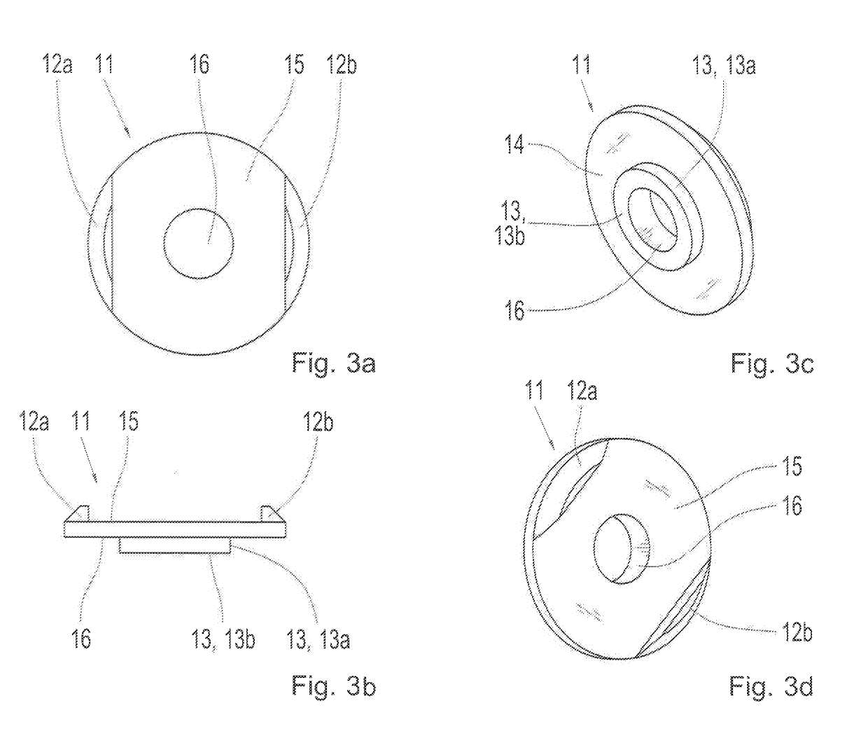

FIGS. 3a, 3b, 3c and 3d show the molded piece 11 from different perspectives. Accordingly, FIG. 3a shows the molded piece 11 in a top view, FIG. 3b shows the molded piece 11 in front view, FIG. 3c shows the molded piece 11 obliquely from behind and FIG. 3d shows the molded piece 11 obliquely from the front.

Viewed from above, the molded piece 11 has a circular shape. On the top or on the top bearing section 15, the molded piece 11 has the two installation sections 12a, 12b. For example, the two installation sections 12a, 12b are formed by a groove, which is formed in the molded piece 11 by means of a cutting process, for example. For example, the molded piece 11 is configured as a cylinder in a primary form, wherein the two installation sections 12a, 12b are formed by a cylindrical recess. The two installation sections 12a, 12b run parallel to each other, wherein the space between the two installation sections 12a, 12b corresponds, for example, to the width of the impact strip 4. For example, the two installation sections 12a, 12b have a height of at least 5 mm.

The contact section 13 has a cylindrical shape and is arranged on the bottom of the molded piece 11 or centered in the middle the bottom bearing section 14. The molded piece hole 16 is a through-hole and is arranged concentrically to the contact section 13 such that the contact section 13 is configured as a hollow cylinder. Viewed from below, the bottom bearing section 14 is configured as a circular ring. The first contact area 13a of the contact section 13 is formed by the outer cylinder surface of the contact section 13 or of the hollow cylinder. The second contact area 13b is formed by the base surface of the contact section 13 or of the hollow cylinder. The molded piece 11 is, for example, formed integrally or in one piece. For example, the molded piece 11 consists of a metal material and/or a plastic material and/or a composite material.

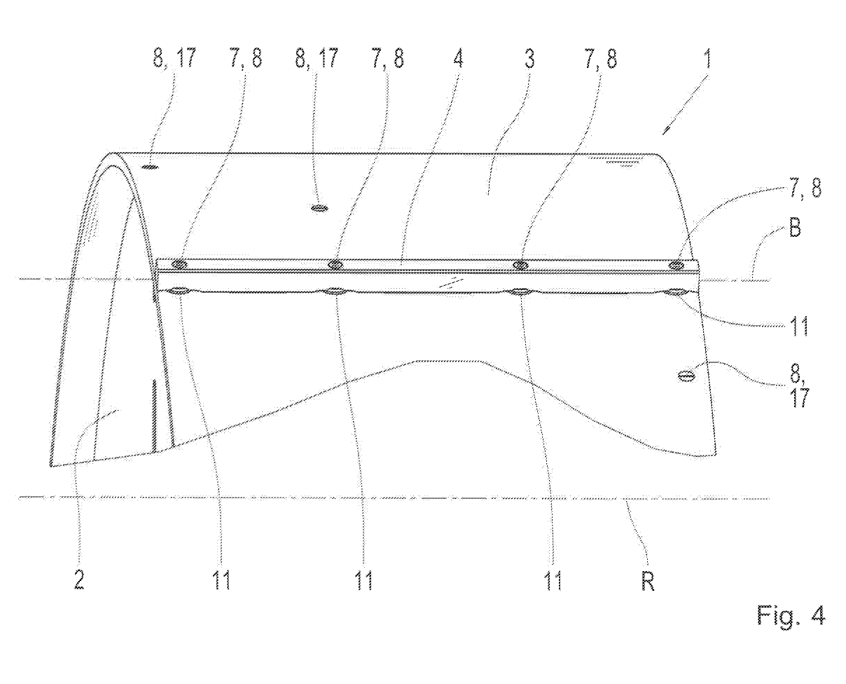

FIG. 4 shows a three-dimensional representation of a section of the running drum arrangement 1. The running drum arrangement 1 has a plurality of fastener mounts 8. The fastener mounts 8 are evenly spaced apart from one another in a circumferential direction and/or in an axial direction with respect to the axis of rotation R on the running surface 3. For example, the fastener mounts 8 are arranged concentrically and/or coaxially to the axis of rotation R in one or more circles.

The impact strip 4 is arranged on the running surface 3, parallel to the axis of rotation R. In this mounting position, the impact strip 4 defines an installation axis B. In particular, the installation axis B is formed by the longitudinal axis or axis of symmetry of the impact strip 4 and runs parallel to the axis of rotation R. In the exemplary embodiment shown, the impact strip 4 has four fastening points, wherein each fastening point lies on the installation axis B. The fastening points are formed by, for example, the fastener mount 8, the molded piece 11 and the fastener 7. Other fastener mounts 8 of the running drum 2 that are not being used for fastening the impact strip 4 are provided with a sealing means 17, e.g., a plug or screw element. The sealing means 17 has the function of protecting the fastener mounts 8 from dirt, for example.

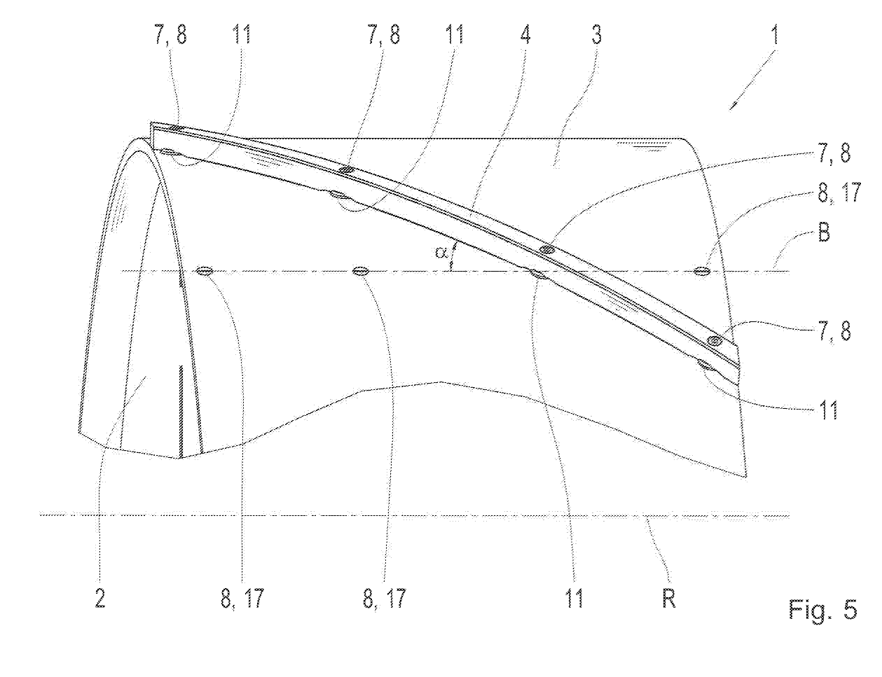

FIG. 5 shows the running drum arrangement 1 depicted in the same way as in FIG. 4, but having an alternative fastening of the impact strip 4. The impact strip 4 is twisted with respect to the installation axis B such that the impact strip 4 and the installation axis B form an angle α. For example, the angle α is 30 or 45 degrees. In the illustration shown, the impact strip 4 has a slightly curved shape, which adapts to the running surface 3 in a circumferential direction such that the impact strip is in contact, for example, with the entire running surface 3. The axial ends of the impact strip 4 are beveled in order to achieve a flush connection to the running surface 3 or to the running drum 2.

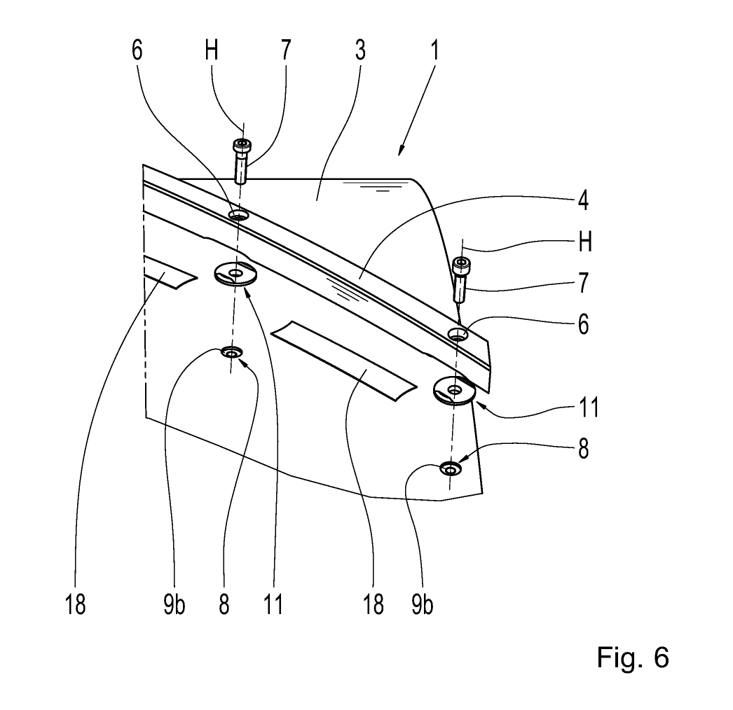

FIG. 6 shows an exploded view of a section of the running drum assembly 1 having the impact strip 4, the fastener 7 and the molded piece 11. The molded piece 11, the fastener 7 and the fastener guidance hole 6 of the impact strip 4 are arranged coaxially to the main axis H. An elastomer layer 18 is arranged between the running surface 3 and the impact strip 4. The elastomer layer 18 is used to prevent damage to the running surface and/or to compensate for tolerances. For example, the elastomer layer is a rubber strip, which for example can be fastened (e.g., glued) to the impact strip bottom 4b and/or to the running surface 3. The elastomer layer 18 is arranged, for example, in part or over the entire area between the impact strip 4 and the running surface 3.

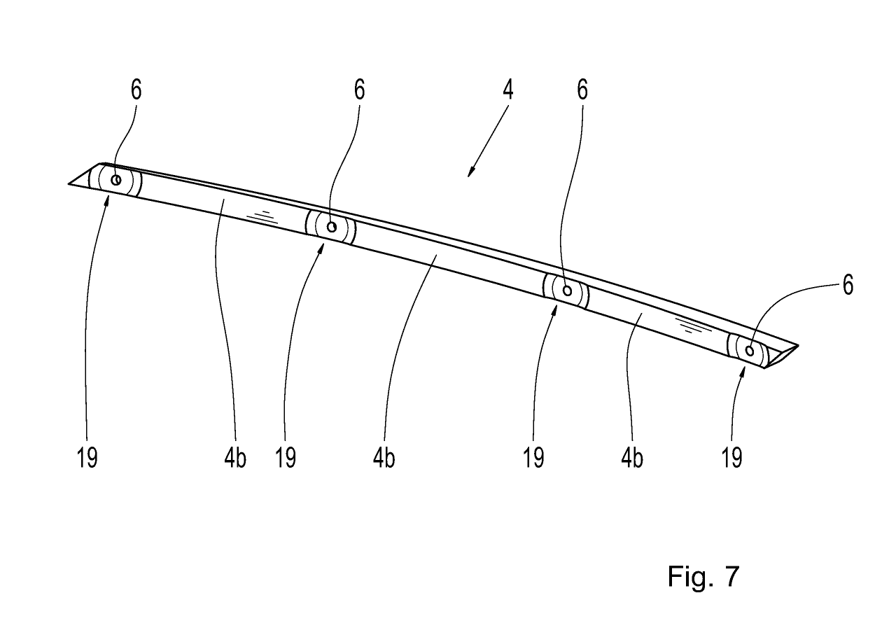

FIG. 7 shows a three-dimensional view of the impact strip 4 viewed from below. The impact strip 4 has four recesses 19 on the impact strip bottom 4b. The recesses 19 are configured in such a way that in each case one of the molded pieces 11 can be received in one of the recesses 19. By virtue of the recesses 19, the impact strip 4 rests with the impact strip bottom 4b entirely or in part on the running surface 3 or the elastomer layer 18. The recesses 19 are spaced evenly apart from one another and extend in the area of the fastener guidance hole 6 over the entire width of the impact strip 4. The recess 19 is delimited in the longitudinal extension of the impact strip 4, wherein the length of the recess 19 in longitudinal extension corresponds at least to the length or diameter of the molded piece 11. For example, the molded piece 11 and the recess 19 form another form fit in the longitudinal extension of the impact strip 4.

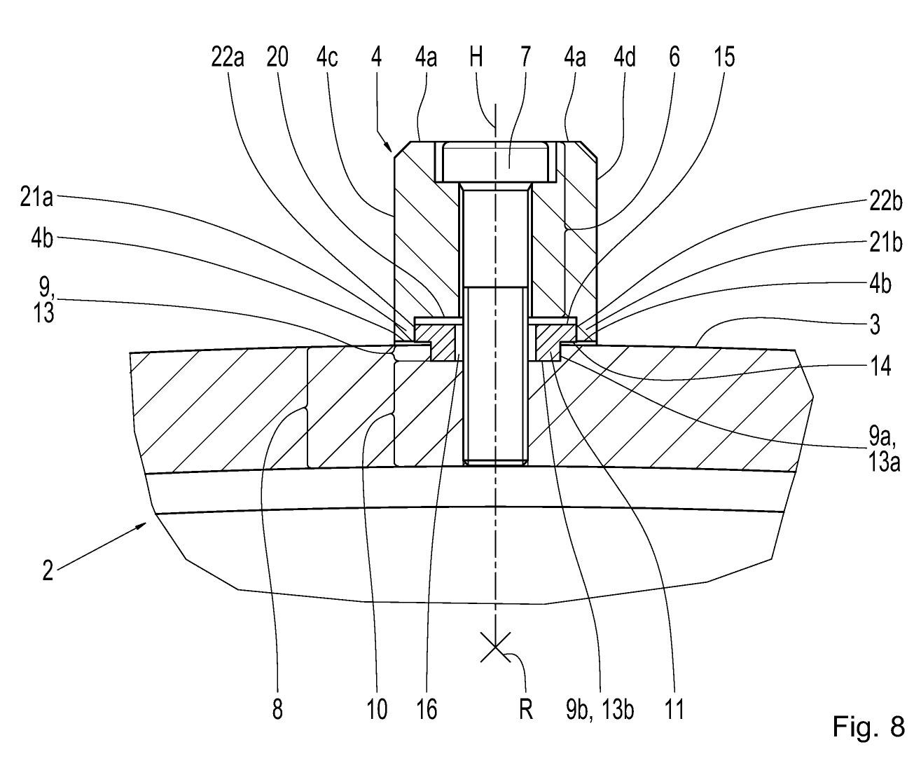

FIG. 8 shows the impact strip 4 depicted in the same way as in FIG. 2 and the molded piece in an alternative engineering implementation. In this case the impact strip 4 has a hollow 20 on the impact strip bottom 4b. The hollow 20 is, for example, a groove that extends entirely or in part in the longitudinal extension of the impact strip 4. The hollow 20 has, for example, a rectangular or trapezoidal cross section. A first web section 21a and a second web section 21b are formed by the hollow 20. In this case the two web sections 21a, 21b are parallel and spaced apart from each other and run, for example, in an axial direction with respect to the axis of rotation R. In the alternative design, the molded piece 11, viewed from above, is flattened on two opposite sides to form a first contact section 22a and a second additional contact section 22b. For example, the molded piece 11 is configured as a cylinder in a primary form, wherein the two additional contact sections 22a, 22b are formed by a flattened cylinder area on both sides.

The two additional contact sections 22a, 22b form, in conjunction with the impact strip 4, in particular in conjunction with the two web sections 21a, 21b, a form fit in a radial direction with respect to the main axis H and/or in a circumferential direction with respect to the axis of rotation R. The first additional contact section 22a abuts the first web section 21a, in particular on an inner side of the first web section 21a. The second contact section 22b abuts the second web section 21b, in particular on an inner side of the second web section 21b. The impact strip 4 engages around the molded piece 11 on both sides, wherein the molded piece 11 is held in a form-fitting manner between the two web sections 21a, 21b.

As has been described in FIG. 2 above, the first contact area 13a abuts the second abutment subsection 9a and forms with the latter a form fit in a radial direction with respect to the main axis H. The second contact area 13b abuts the second abutment subsection 9b and forms, with the second abutment subsection 9b, a form fit in an axial direction with respect to the main axis H. Alternatively, or optionally in addition, the bottom bearing section 14 rests entirely or partly on the running surface 3.

The impact strip bottom 4b rests on the running surface 3 and/or on the elastomer layer 18 to form a form fit in an axial direction with respect to the main axis H and/or in a radial direction with respect to the axis of rotation R. Alternatively, or optionally in addition, a base surface of the hollow 20 rests on the top bearing section 15 such that in particular the impact strip bottom 4b and the running surface 3 and/or the base surface of the hollow 20 and the top bearing section 15 form a form fit in an axial direction with respect to the main axis H and/or in a radial direction with respect to the axis of rotation R.

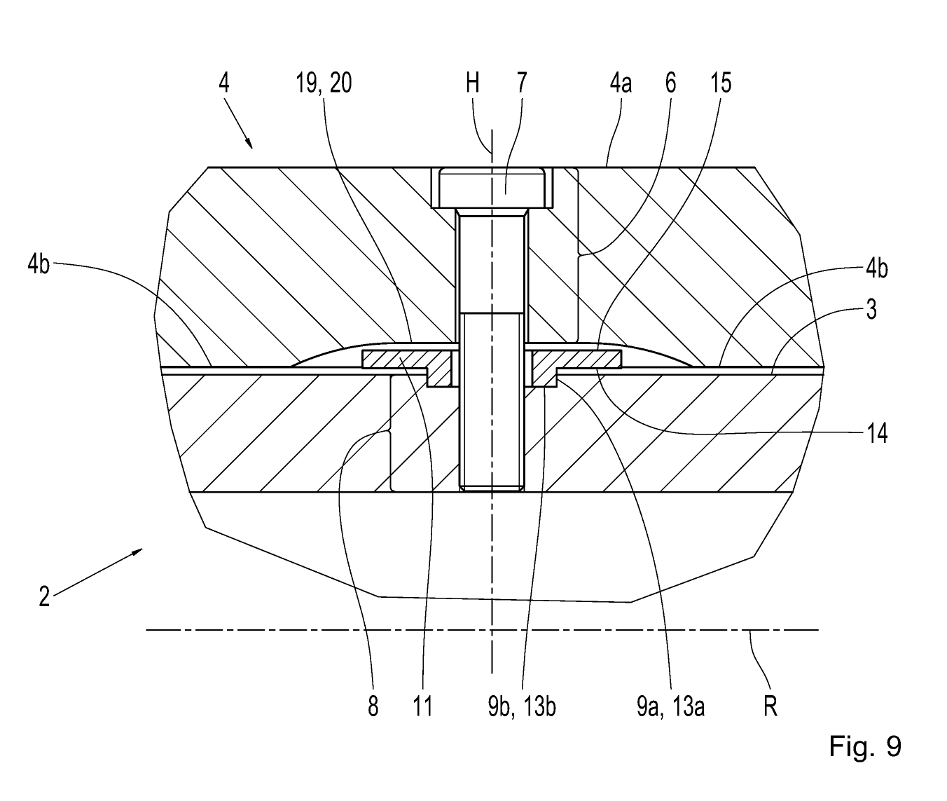

FIG. 9 shows the impact strip 4, the fastener 7, the molded piece 11 and the running surface 3 or the running drum 2, in a longitudinal section along the main axis H. The recess 19 and/or the hollow 20 are formed by, for example, a disc grinder, wherein the molded piece 11 is spaced apart from the recess 19 and/or from the hollow 20 in a radial direction and/or in an axial direction with respect to the axis of rotation R.

### LIST OF REFERENCE SIGNS

1 Running drum arrangement
2 Running drum
3 Running surface
4 Impact strip
4a Impact strip top
4b Impact strip bottom
4c First impact strip side face
4d Second impact strip side face
5 Running drum mount
6 Fastener guidance hole
7 Fastener
8 Fastener mount
9 Abutment section
9a First abutment subsection
9b Second abutment subsection
10 Mounting section
11 Molded piece
12a First installation section
12b Second installation section
13 Contact section
13a First contact area
13b Second contact area
14 Bottom bearing section
15 Top bearing section
16 Molded piece hole
17 Sealing means
18 Elastomer layer
19 Recess
20 Hollow
21a First web section
21b Second web section
22a First additional contact area
22b Second additional contact area
R Axis of rotation
H Main axis
B Installation axis

1-12. (canceled)

13. A running drum arrangement (1) for a tire testing stand, the running drum arrangement comprising:
a running drum (2),
the running drum (2) defining an axis of rotation (R),
the running drum (2) having at least one fastener mount (8),
the fastener mount (8) defining a main axis (H),
at least one impact strip (4) being arranged on a radially outer side of the running drum (2) with respect to the axis of rotation (R),
at least one fastener (7) fastening the impact strip (4) on the running drum (2), and the fastener (7) being mounted to the fastener mount (8),
wherein the running drum arrangement (1) has at least one molded piece (11),
the molded piece (11) is arranged between the running drum (2) and the impact strip (4),
the molded piece (11) forms, in conjunction with the running drum (2) and with the impact strip (4), a form fit in a circumferential direction with respect to the axis of rotation (R); and
during a first installation step of the impact strip (4), the molded piece (11) is inserted into the fastener mount (8),
during a second installation step, the impact strip (4) is positioned on the molded piece (11), and
during a third installation step, the fastener (7) is introduced such that the impact strip (4) and the molded piece (11) are then radially locked to the running drum (2) toward the axis of rotation (R) by the fastener (7).

14. The running drum arrangement (1) according to claim 13, wherein the molded piece (11) forms a first form fit coupling to couple the impact strip (4), and the molded piece (11) forms a second form fit coupling to couple the running drum (2), and the first form fit coupling absorbs a load, in a circumferential direction, and transmits the load to the running drum (2) via the second form fit coupling.

15. The running drum arrangement (1) according to claim 14, wherein the molded piece (11) has first and second installation sections (12a, b), the first and the second installation sections (12a, b) encompass the impact strip (4), on both sides, and form the first form fit coupling in a radial direction with respect to the main axis (H), and the first and the second installation sections (12a, b) absorb a force acting on the impact strip (4).

16. The running drum arrangement (1) according to claim 15, wherein at least one of:
the first installation section (12a) abuts, in a form-fitting manner, a first side face (4c) of the impact strip (4); and
the second installation section (12b) abuts, in a form-fitting manner, a second side face (4d) of the impact strip (4).

17. The running drum arrangement (1) according to claim 14, wherein the fastener mount (8) has an abutment section (9) and the molded piece (11) has a contact section (13), and the contact section (13) forms, with the abutment section (9), the second form fit coupling in at least one of a radial and an axial direction with respect to the main axis (H).

18. The running drum arrangement (1) according to claim 13, wherein the molded piece (11) has a bottom bearing section (14), the bottom bearing section (14) abuts the running drum (2) and forms, in conjunction with the running drum (2), a form fit in the radial direction with respect to the axis of rotation (R).

19. The running drum arrangement (1) according to claim 13, wherein the molded piece (11) has a top bearing section (15), and the top bearing section (15) abuts a bottom of the impact strip (4) and forms, with the impact strip (4), a form fit in a radial direction with respect to the axis of rotation (R).

20. The running drum arrangement (1) according to claim 13, wherein the impact strip (4) has a recess (19) on a bottom thereof for mounting the molded piece (11), the recess (19) partially extends in an area of the molded piece (11) in at least one of a longitudinal extension and a transverse extension of the impact strip (4).

21. The running drum arrangement (1) according to claim 13, wherein the impact strip (4) has a hollow (20) on a bottom thereof, the hollow (20) extends at least one of partially or entirely in at least one of a longitudinal extension and a transverse extension of the impact strip (4), the hollow (20) forms at least first and second web sections (21a, b), and the first and the second web sections (21a, b) encompass the molded piece (11) on both sides.

22. The running drum arrangement (1) according to claim 13, wherein the impact strip (4) is fixable on the running drum (2) either parallel to or skewed with respect to the axis of rotation (R).

23. The running drum arrangement (1) according to claim 13, wherein an elastomer layer (18) is arranged, either in sections of over an entire area, between the impact strip (4) and the running drum (2).

24. A tire testing stand having a running drum arrangement (1) having a running drum (2), the running drum (2) defining an axis of rotation (R), the running drum (2) having at least one fastener mount (8), the fastener mount (8) defining a main axis (H), at least one impact strip (4) being arranged on a radially outer side of the running drum (2) with respect to the axis of rotation (R), at least one fastener (7) fastening the impact strip (4) to the running drum (2), and the fastener (7) being mounted to the fastener mount (8), the running drum arrangement (1) having at least one molded piece (11), the molded piece (11) being arranged between the running drum (2) and the impact strip (4), the molded piece (11) forming, in conjunction with the running drum (2) and with the impact strip (4), a form fit in a circumferential direction with respect to the axis of rotation (R); and
during a first installation step of the impact strip (4), the molded piece (11) is inserted into the fastener mount (8),
during a second installation step, the impact strip (4) is positioned on the molded piece (11), and
during a third installation step, the fastener (7) is introduced such that the impact strip (4) and the molded piece (11) are then radially locked to the running drum (2) toward the axis of rotation (R) by the fastener (7).
